(19) United States
(12) Patent Application Publication
(10) Pub. No.: US 2015/0162812 A1
(43) Pub. Date: Jun. 11, 2015

(54) Heat Sink for a Linear Motor, and Linear Motor Having a Heat Sink

(71) Applicant: ETEL S.A., Motiers (CH)

(72) Inventor: André-Rafael Da Conceição Rosa, La Chaux-de-Fonds (CH)

(21) Appl. No.: 14/563,606

(22) Filed: Dec. 8, 2014

(30) Foreign Application Priority Data
Dec. 11, 2013 (EP) 13 196 738.2

(51) Int. Cl. H02K 41/02; H02K 9/22

(52) U.S. Cl. CPC H02K 41/02; H02K 9/22

(57) ABSTRACT

A heat sink for the primary section of a linear motor, which includes a coil assembly having at least one coil to be supplied with current during operation of the motor, is bounded by a circumferential outer edge and is adapted to accommodate the coil assembly of the primary section. The heat sink is arranged as an assembly formed in one piece, on which a mounting section is integrally molded circumferentially along the outer edge, the mounting section defining at least one contact area for the positioning of a closing plate, such that, when at least one closing plate is mounted as intended on the mounting section, a space is formed, bounded by the heat sink and the at least one closing plate, in which the coil assembly is accommodated.

### CROSS-REFERENCE TO RELATED APPLICATIONS

The present application claims priority to Application No. 13196738.2, filed in the European Patent Office on Dec. 11, 2013, which is expressly incorporate herein in its entirety by reference thereto.

### FIELD OF THE INVENTION

The present invention relates to a heat sink for the primary section of a linear motor and to a linear motor having such a heat sink.

### BACKGROUND INFORMATION

Linear motors are being used increasingly when an extremely precise and possibly also rapid positioning of objects such as, for example, a machine part of a machine tool are involved. In this case, the primary section of the linear motor is able to be connected via a suitable interface directly to the machine part or other object to be moved. That is to say, in contrast to a conventional rotary motor, there is no need to connect a gear unit between the linear motor and the object to be driven.

For practical applications which require particularly precise positioning, above all what are termed ironless linear motors are suitable, in which no iron core is assigned to the at least one coil provided on the primary section. In this manner, disturbing cogging thrusts may be avoided. However, correspondingly greater coil currents are necessary in order to be able to generate sufficiently great forces at the primary section of the linear motor even without an iron core. This in turn requires correspondingly sufficient cooling of the coil(s) (also referred to generally hereinafter as coil assemblies).

In an ironless linear motor, the heat sink may at the same time be used as accommodation for the coil assembly of the primary section. Such an ironless linear motor is described, for example, in U.S. Pat. No. 7,057,313.

If a linear motor having a heat sink is to be used in an evacuated space, (i.e., under vacuum conditions), there is then the difficulty that customary coil assemblies, because of trapped air between the windings of the coils or because of outgassing insulation, for example, are not well-suited for use in vacuum.

### SUMMARY

Example embodiments of the present invention improve the usability of a linear motor in vacuum.

According to example embodiments of the present invention, in the case of a heat sink for the primary section of a linear motor which is bounded by a circumferential outer edge and which is designed to accommodate the coil assembly of the primary section of the linear motor, it is further provided that the heat sink is provided as an assembly formed in one piece, on which at least one mounting section is integrally molded extending annularly along its outer edge. The mounting section in turn defines at least one circumferential contact area for at least one closing plate, such that when the closing plate(s) is/are mounted as intended on that contact area, a space is formed which is bounded by the heat sink, particularly its mounting section, as well as by the at least one closing plate, and in which the coil of the coil assembly to be disposed on the heat sink is accommodated according to the intended purpose. At the same time, the space bounded by the heat sink and the at least one closing plate may, in particular, be sealed in gas-tight fashion, so that a coil assembly located in it cannot interact with the surroundings upon use of the linear motor in vacuum.

In this context, the provision that the mounting section encircles along the outer edge of the heat sink does not mean that the mounting section must necessarily extend directly on the edge of the heat sink, but rather that it may also be set apart from it. The mounting section may also be subdivided into several subsections.

The mounting section extending annularly along the outer edge of the heat sink may have two circumferential contact areas, facing away from each other, for one closing plate each, so that given the intended placement of one closing plate on each of the two contact areas, two spaces are bounded by the heat sink and the two closing plates, and a portion of the coils of a coil assembly may be accommodated in each of the two spaces (on both sides of the heat sink).

The (respective) contact area on the mounting section may be stepped, and one respective closing plate is to be placed as intended on one step of the contact area, and at the same time, may additionally be braced laterally at the junction between two steps, so as to ensure an especially tight connection between a respective closing plate and the mounting section of the heat sink.

In order to perform its cooling function, the heat sink, especially in a cooling area arranged as a cooling plate, may form at least one channel which is traversed by a coolant during operation of the heat sink, and in addition, may have at least one inlet and at least one outlet for the coolant.

A heat sink formed in one piece, which has a (plate-shaped) cooling member, may be produced by what is referred to as 3-D printing, for example, with the aid of a 3-D printer which produces the heat sink from one or more fluid or powder materials with specific dimensions and shapes. However, other production methods may be utilized for producing a heat sink formed in one piece, such as joining with material locking, especially welding, of at least two plate parts (plate halves), into which grooves have been introduced (e.g., milled) beforehand to form channels for the coolant.

That is, a heat sink formed in one piece should be understood to be one which has been produced as one assembly in a profiling process (without additional subsequent joining steps between individual components of the heat sink) or in which additional material-locking bonds, e.g., welded joints, may be provided if needed between components of the heat sink. In this connection, the first alternative, especially in the form of a heat sink produced by 3-D printing, is regarded as especially advantageous. In this context, the consequential components of a heat sink which form the one-piece assembly are those which receive the coolant and lead into the heat sink, e.g., especially the outer walls of the heat sink and the channels formed in the heat sink for the coolant.

Titanium is suitable as a material for the heat sink, which, as a metal, exhibits high thermal conductivity accompanied at the same time by comparatively high specific resistivity, the latter counteracting the generation of eddy currents in the heat sink. Other suitable materials include stainless steel, for example, or (electrically-insulating, non-water-absorbent) ceramic materials such as those described in U.S. Pat. No. 7,057,313, for example.

Additionally, not only the coolant inlet and the coolant outlet (for example, in the form of an intake orifice and discharge orifice, respectively), but also in each case an associated connection area, via which a supply line or a discharge line for the coolant is connectable to the inlet and outlet, respectively, may be integrally molded in one piece on the heat sink. An electrical connection of the coil assembly may also be formed on the heat sink.

Furthermore, mounting elements may be integrally molded in one piece on the heat sink, via which the at least one coil of the primary section is able to be secured in position on the heat sink. For example, the mounting elements may take the form of snap-in locking elements via which a respective coil may be latched to the heat sink, or perhaps may take the form of mounting openings. Besides a snap-in connection, e.g., a screw connection (possibly using mounting openings) may be provided for the connection of the heat sink and a respective coil. By defined fixation of the coil(s) on the heat sink, especially accompanied by the generation of a certain contact pressure, a defined heat transfer may be ensured between a coil to be cooled in each case and the heat sink.

The heat sink may be arranged such that it has an entrance area downstream of the at least one coolant inlet, into which the coolant, supplied via the inlet, initially flows. From this entrance area, channels may branch off, in which the coolant is conducted along the coil(s) to be cooled in the primary section. The channels directed along the primary section to be cooled in turn open through into a discharge area of the heat sink, from which the coolant (by this time warmed up) is removed via the coolant outlet.

The entrance area and the discharge area of the heat sink may be disposed on both sides of the channels for the coolant, which in each instance extend from the entrance area to the discharge area accordingly. That is, the entrance area and discharge area of the heat sink are set apart from each other along the extension direction of the channels. However, a loop-shape course of the channels for the coolant is also possible, such that the entrance area and discharge area of the heat sink extend side-by-side. In this case, a non-heat-conducting material may be provided between the entrance area and the discharge area of the heat sink in order to avoid a heat exchange.

The entrance area and/or the discharge area of the heat sink may be arranged as a longitudinally-extended hollow section from which the channels of the heat sink branch off (substantially transversely) or into which the channels of the heat sink lead (substantially transversely).

In each case, a plurality of channels of the heat sink, which extend side-by-side, may take a course along a coil form of the primary section. The pressure drop along the channels may thereby be limited.

To reduce the pressure drop along the direction of flow of the coolant, in addition, the channels and other areas of the heat sink may be arranged such that obstacles in the flow path as well as curves having small radii are avoided to the greatest extent possible.

In each case one channel or a plurality of channels may form one cooling section which is used in each instance for the cooling of one coil of the coil assembly.

On the heat sink, particularly between individual cooling sections of the heat sink and therefore within the region surrounded by the mounting section, support areas or reinforcement areas, especially in the form of ribs, may be provided (formed in one piece), on which the closing plates, upon intended placement on a contact surface of the mounting section, may be additionally supported in each case, and on which a closing plate—in addition to the fixation on a contact surface of the mounting section—may be fixed in position.

A respective closing plate, which is to be placed and secured as intended on the heat sink, may be made of metal, for example. The same material may be used for the heat sink on one hand and the at least one associated closing plate on the other hand. However, the use of different materials is also possible.

A respective closing plate may be fixed in position with material locking, especially by welding or specifically by laser welding, on a respective contact area of the mounting section and/or on the support or reinforcement areas.

Further features and aspects of example embodiments of the present invention are described in more detail below with reference to the appended Figures.

### BRIEF DESCRIPTION OF THE DRAWINGS

FIG. 1 is a perspective view of a heat sink of a primary section for a linear motor.

FIG. 1A is an enlarged cross-sectional view of the heat sink illustrated in FIG. 1.

FIG. 2 is a plan view of the heat sink illustrated in FIG. 1 illustrating courses of channels within the heat sink.

FIG. 3A is an exploded view of the heat sink illustrated in FIG. 1 together with two closing plates to be secured to it.

FIG. 3B is a perspective view of the configuration illustrated in FIG. 3A after the closing plates are secured to the heat sink.

FIG. 4 is a perspective view of a heat sink together with a coil assembly of a primary section of a linear motor.

### DETAILED DESCRIPTION

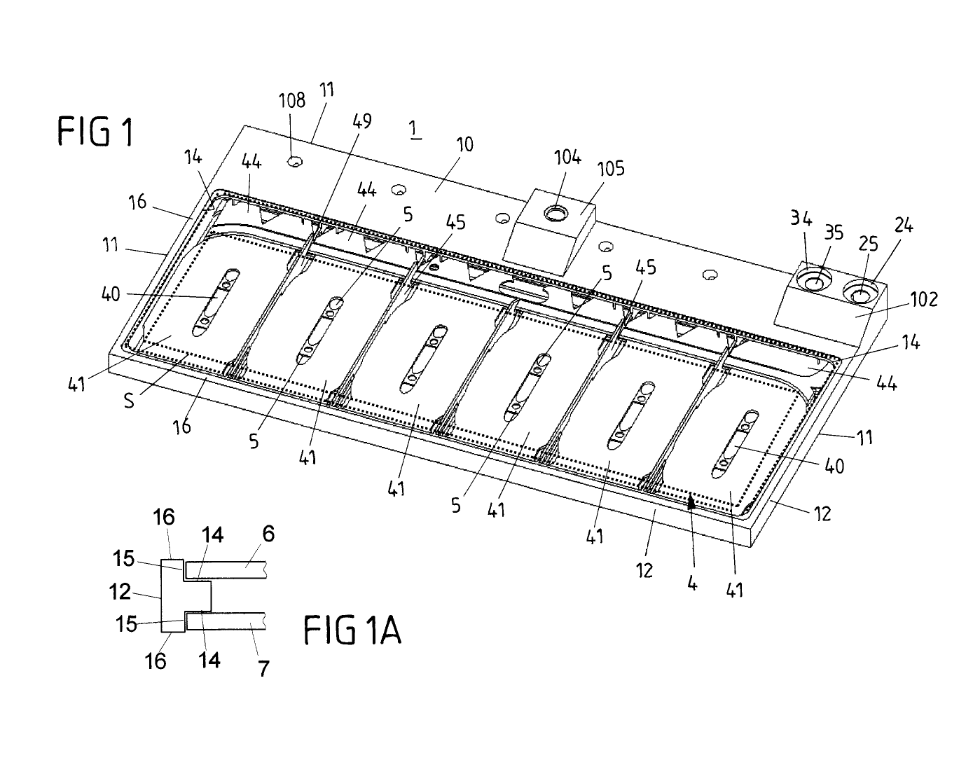

To illustrate the technical background of the exemplary embodiment described below with reference to FIGS. 1 to 3B, FIG. 4 illustrates a cooling plate K on which coils S1, S2, S3 and S1′, S2′, S3′, respectively, of a primary section P of a linear motor are disposed (on both sides, which is not imperative however, or only on one side). Each planar coil S1, S2, S3; S1′, S2′, S3′ is formed of a wire, e.g., copper wire, which is wound about a central opening of the respective coil. The winding of the coils is implemented, for example, such that although many wires lie flat side-by-side in one plane, only one or a few layers of such windings are formed perpendicular to the coil plane. Such a coil form leads, on one hand, to a flat construction of the primary section, and on the other hand, permits a large-area contact with the—likewise planar—heat sink K in the form of a cooling plate.

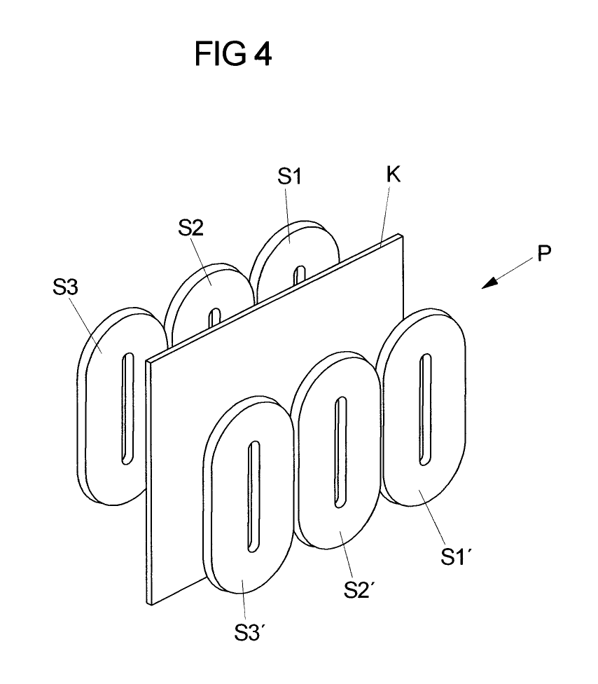

In its interior, heat sink K has cooling channels, through which a coolant, especially in the form of a cooling liquid, flows during operation of the corresponding motor, in order to cool coils S1, S2, S3; S1′, S2′, S3′, e.g., especially to prevent the coils from heating too much as a result of the current flowing through the coils during motor operation. Since the primary section illustrated in FIG. 4 is what is referred to as an ironless primary section, heat sink K also takes over the function of accommodating coils S1, S2, S3; S1′, S2′, S3′.

FIG. 1, in a perspective view, illustrates a heat sink 1, which is used to cool the coils of a primary section of an (ironless) linear motor, a coil assembly S being indicated with dotted lines in FIG. 1. With regard to a possible layout of coil assembly S, reference is made, for example, to FIG. 4 explained above.

As illustrated in FIG. 1, heat sink 1 is a single assembly formed in one piece. A metal with good thermal conductivity accompanied at the same time by comparatively high specific electrical resistance, such as titanium or stainless steel, for example, is suitable as material for heat sink 1. A sufficient thermal conductivity of the heat sink ensures the dissipation of the heat, generated during operation of coil assembly S, into a coolant located in heat sink 1. A sufficiently great specific resistivity counteracts the development of eddy currents in heat sink 1.

3-D printing, for example, is suitable for producing heat sink 1 formed in one piece, especially from metal. An alternative possibility for manufacture is, for example, the welding of at least two plate parts (plate halves), into which grooves have been introduced (e.g., milled) beforehand to form channels for the coolant.

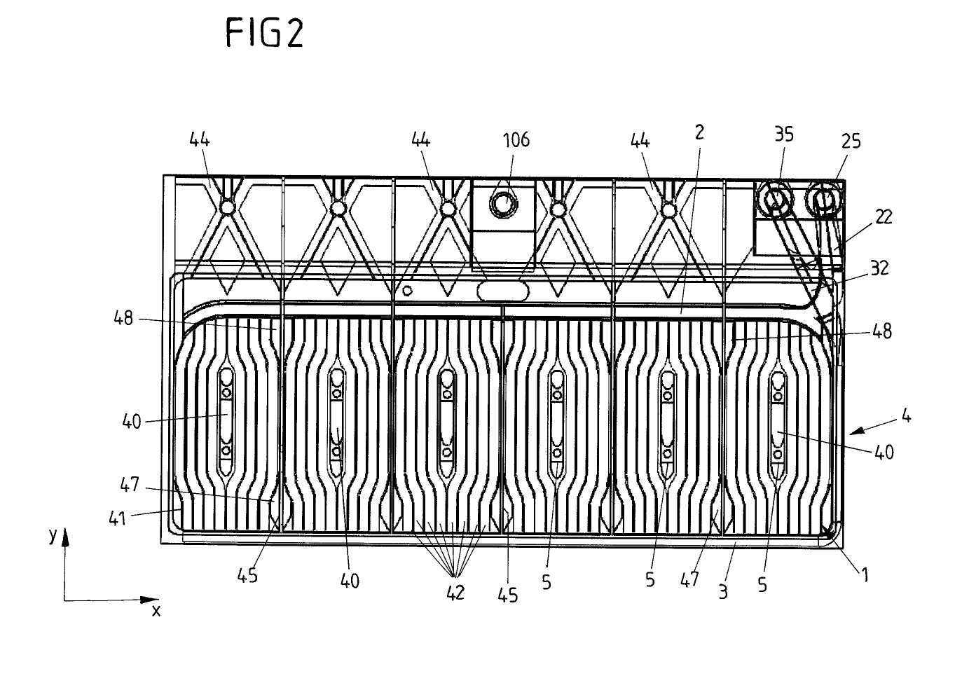

In the exemplary embodiment illustrated, heat sink 1 has a cooling plate 4, in order on one hand to minimize the overall height of the primary section, and on the other hand, to permit contact over as large a surface as possible with coil assembly S of the primary section. Channels for the coolant are provided in heat sink 1, which are described in greater detail below with reference to FIG. 2 and which are used for the defined conduction of a coolant admitted into the heat sink, especially a cooling liquid, along coil assembly S.

As illustrated in FIGS. 1 and 2, heat sink 1 has a coolant inlet 25 and a coolant outlet 35. Both coolant inlet 25 and coolant outlet 35 are integrally molded in one piece on heat sink 1. Specifically, inlet 25 and outlet 35 are each formed on a coolant port 102 integrally molded in one piece on heat sink 1. Coolant port 102 defines connection areas 24, 34, of which the one is assigned to coolant inlet 25 and the other to coolant outlet 35. Connection area 24 assigned to coolant inlet 25 is used for the connection of a supply line for a coolant, and connection area 34 assigned to coolant outlet 35 is used for the connection of a drainage line for the coolant.

As illustrated in FIG. 2, coolant inlet 25 is in flow connection with an entrance area 2 of heat sink 1 via a connecting channel 22. Entrance area 2 extends (is longitudinally extended) next to coil assembly S of the primary section. Moreover, coolant outlet 35 is in flow connection with a discharge area 3 of heat sink 1 via a connecting channel 32. Discharge area 3 likewise extends (is longitudinally extended) next to coil assembly S of the primary section, however, on a side of coil assembly S facing away from entrance area 2.

Projecting laterally from entrance area 2 are a plurality of cooling sections 41 of heat sink 1, which are used to cool the individual coils of coil assembly S and which form, for example, a cooling plate. Cooling sections 41 are disposed side by side in the plane of heat sink 1, e.g., in the xy-plane defined by cooling area 4 in the form of a cooling plate.

Therefore, from entrance area 2, the coolant (admitted via coolant inlet 25) is able to flow into coolant sections 41—projecting laterally from entrance area 2—of (plate-shaped) cooling area 4, against which the coils of coil assembly S abut (on one side or both sides) (see FIG. 4). Each cooling section 41 projecting from entrance area 2 of the heat sink is planar and surrounds an opening 40. Each of these cooling sections 41 is provided to cool one coil or two mutually opposite coils of the primary section, which is/are to be disposed on cooling section 41 assigned in each case.

Mounting elements 5 integrally molded on heat sink 1, or more precisely, on cooling sections 41 (and provided in each case within associated opening 40) are used to secure the coils on heat sink 1, i.e., on a respective cooling section 41. The individual coils may be secured to heat sink 1, that is, to respective cooling section 41, with a certain contact pressure in order to optimize the transfer of heat between the heat sink and the coil. For example, each mounting element 5 may have a mounting opening which makes it possible to secure a respective coil with the aid of a screw engaging in it or with the aid of a snap-in locking element engaging in it. Alternatively, mounting elements 5 may include detent hooks which wrap around corresponding detent sections on a coil to be secured, or grip them from behind.

In order to supply current to the coils located on heat sink 1, a connecting piece 105 is integrally molded on the heat sink and has an interface 104, at which an electrical plug connector is able to be disposed, e.g., by securing the electrical plug connector on interface 104 of connecting piece 105 by welding.

In the plan view of FIG. 2, heat sink 1, and especially its cooling area 4, is illustrated in a partially translucent manner, so that the channels formed within heat sink 1 are visible. Accordingly, each cooling section 41 forms several (e.g., eight) channels 42. They extend on both sides of central opening 40 of respective cooling section 41, and in each case are disposed side-by-side transversely to their extension direction. Each of channels 42 branches off from entrance area 2 of the heat sink, extends in the direction of discharge area 3 and opens through into it. By subdividing a respective cooling section 41 into a plurality of channels 42 extending side-by-side, the pressure drop within a respective cooling section 41 is reduced. In addition, the form of cooling sections 41 is aimed at optimizing the heat exchange with the coil assigned in each case.

During operation of the heat sink—illustrated in FIGS. 1 and 2—for cooling a coil assembly S of the primary section of a linear motor, a supply line is connected to the one input-side connection area 24 of the heat sink, by which a coolant, especially a cooling liquid, e.g., in the form of water, possibly mixed with glycol, is supplied to heat sink 1 by coolant inlet 25 formed on connection area 24 on the input side. The coolant then flows via connecting channel 22 into entrance area 2 of the heat sink, which extends along a first direction x in the exemplary embodiment illustrated. From entrance area 2, the coolant flows into cooling sections 41 projecting laterally from it, or more precisely, into their individual channels 42 formed in each cooling section 41. The channels branch off substantially perpendicularly (along a second direction y) from entrance area 2 (extending along a first direction x). They then extend side-by-side within a respective cooling section 41 as already described, on both sides of central opening 40 of respective cooling section 41 and open through, again substantially perpendicularly (along second direction y), into discharge area 3 of heat sink 1. In the exemplary embodiment illustrated, discharge area 3 extends parallel to entrance area 2 along first direction x, and specifically, on the other opposite side of cooling area 4.

In discharge area 3, the coolant coming from cooling sections 41, that is, their channels 42, then flows along first direction x first of all to connecting channel 32, and through it to coolant outlet 35, where the coolant may be removed via a drainage line connected to corresponding connection area 34. Coolant outlet 35 is disposed on heat sink 1 next to coolant inlet 25, and, for example, is formed on one common coolant port 102 in the exemplary embodiment illustrated.

In summary, a coolant is fed into heat sink 1 initially via its coolant inlet 25 into entrance area 2, from which it flows into channels 42 of cooling sections 41 projecting laterally from entrance area 2, where the coolant is used to cool coil assembly S of the primary section. From cooling sections 41, the coolant arrives in discharge area 3 of the heat sink, which extends (along a first direction x) substantially parallel to entrance area 2, but set apart (transversely to first direction x) from entrance area 2. In this manner, the coolant, which has heated up beforehand in cooling sections 41, does not come in heat-conducting contact with the coolant still in entrance area 2. The coolant ultimately leaves discharge area 3 via coolant outlet 35, which is disposed next to coolant inlet 25 in the exemplary embodiment illustrated.

The flow paths in heat sink 1, especially also channels 42 in cooling sections 41, are provided such that obstacles in the flow path of the coolant as well as curved paths with large curvature (i.e., small radius of curvature) are avoided. The pressure drop of the coolant along its flow path is thereby minimized.

In manufacturing a heat sink formed in one piece, as illustrated in FIGS. 1 and 2, the manufacturing costs are substantially co-determined by the material costs. In order to reduce them, heat sink 1 is therefore made as thin-walled as possible. Furthermore, material is only used at those locations of the heat sink where it is actually necessary. For example, areas 47, 48 between individual cooling sections 41 therefore remain free.

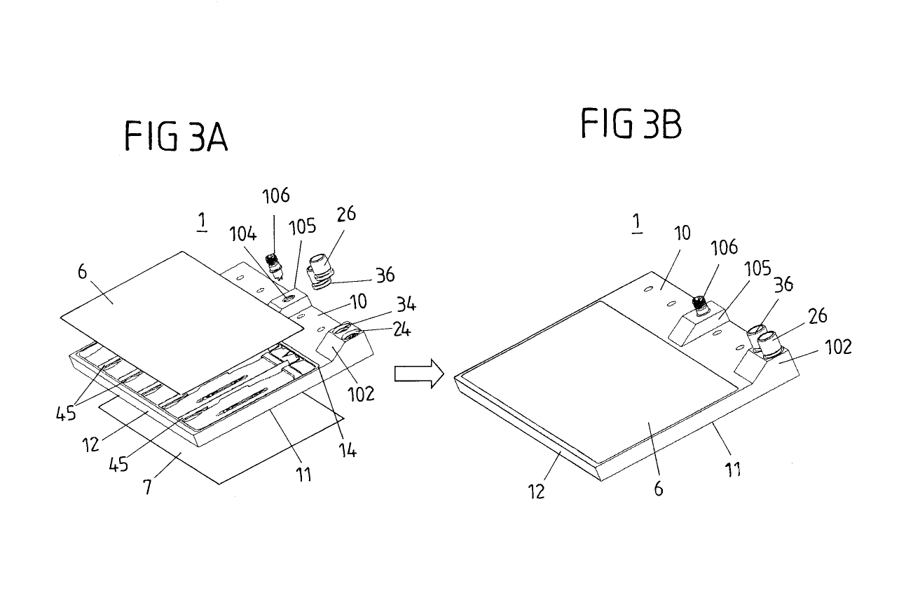

As illustrated in FIGS. 1 and 2, located in each case between individual cooling sections 41 of heat sink 1 are support or reinforcement areas 45, in the form of ribs in the exemplary embodiment illustrated, via which adjacent cooling sections 41 are joined to each other section-by-section. One function of these reinforcement or support areas is described in greater detail below with reference to FIGS. 3A and 3B.

According to FIGS. 1 and 2 as well as the cross-section of a detail of FIG. 1 illustrated in FIG. 1A, heat sink 1 is bounded by a circumferential outer edge 11. It extends along a plane (xy-plane) which is defined by heat sink 1, i.e., its plate-shaped cooling area 4.

A mounting section 12 of heat sink 1 extends along circumferential outer edge 11, but not necessarily on it. In the exemplary embodiment illustrated in FIGS. 1 and 2, mounting section 12 extends sectionally directly on edge 11 of heat sink 1, and on the other hand, is set apart from it sectionally. In the part of heat sink 1 in which mounting section 12 is set apart from outer edge 11 of the heat sink, formed between outer edge 11 and mounting section 12 is a holder area 10, on which, for example, coolant inlet 25, coolant outlet 35 and interface 104 for an electrical plug connector are provided. Also formed on that holder area 10 are mounting locations 108, e.g., in the form of mounting openings, via which heat sink 1, and with it also a coil assembly disposed on it, is able to be attached to an assigned object such as a machine part, for example.

In addition, in the vicinity of holder area 10, plate-shaped cooling area 4 (having cooling sections 41) is joined via diagonal reinforcement or stiffening members 44 to outer edge 11 of heat sink 1.

Mounting section 12 of heat sink 1 projects (e.g., perpendicularly to extension plane xy of heat sink 1) on both sides beyond plate-shaped cooling area 4 of heat sink 1, and in each case forms a stepped end area 14, 15, 16 at its free ends (see FIG. 1A). In this context, one step 14 forms a contact area for in each instance one closing plate 6, 7. Closing plates 6, 7 may be made of metal, and, for example, of the same material as heat sink 1.

As illustrated in FIGS. 1A, 3A and 3B, by positioning and securing one closing plate 6, 7 each on the two contact areas 14 of heat sink 1, a space may be formed which is enclosed by those closing plates 6, 7 and heat sink 1 (particularly also by its mounting section 12), and in which the coils of coil assembly S secured on the cooling area are accommodated (see FIGS. 1 and 4). Because respective closing plates 6, 7 are fixed in position in gas-tight fashion, e.g., by welding, especially laser welding on respective associated contact areas 14 of mounting section 12, the interior space which is bounded by heat sink 1 and closing plates 6, 7 and in which coil assembly S is accommodated is able to be sealed in gas-proof manner. This is particularly advantageous for use of the assembly in evacuated spaces (vacuum), since coil assembly S is thereby isolated from the surroundings (vacuum), and in particular, no gas emissions are able to get into the surroundings. In this context, the laser welding may be carried out straight through respective closing plates 6, 7.

A (gas-tight) connection between closing plates 6, 7 and mounting section 12 may be ensured particularly reliably if closing plates 6, 7 not only abut against respective assigned contact areas 14, but in addition, are braced laterally against junction 15 to a next step 16 of mounting section 12. In this case, junction region 15 may be inclined to produce a wedge effect.

For maximum stability of the assembly, closing plates 6, 7 may additionally be supported on support or reinforcement areas 45 (formed by ribs in the exemplary embodiment illustrated) between cooling sections 41 and secured, e.g., welded, to them, as well.

In addition, it is illustrated in FIGS. 3A and 3B that at connection areas 24, 34 of heat sink 1, in each case a connecting piece 26 and 36, respectively, for a coolant hose is disposed and attached (e.g., by welding, especially laser welding), via which, on one hand, a coolant is able to be fed to coolant inlet 25, and on the other hand, by which the coolant (warmed up in the meantime) is able to be removed again via coolant outlet 35.

Moreover, an electrical plug connector 106 may be disposed at electrical interface 104 and fixed in position (e.g., again by welding, especially laser welding).

What is claimed is:

1. A heat sink for a primary section of a linear motor, that includes a coil assembly having at least one coil to be supplied with current during operation of the motor, the heat sink being bounded by a circumferential outer edge and being adapted to accommodate the coil assembly of the primary section, comprising:
an integral assembly including a mounting section integrally molded circumferentially along the outer edge, the mounting section defining at least one contact area adapted to position a closing plate, such that, when at least one closing plate is mounted on the mounting section, a space is formed, bounded by the heat sink and the at least one closing plate, in which the coil assembly is accommodatable.

2. The heat sink according to claim 1, wherein the mounting section includes two contact areas, facing away from each other, for one closing plate each, such that when one closing plate each is mounted on a respective contact area of the mounting section, a space is formed, bounded by the heat sink and the closing plates, in which the coil assembly is accommodatable.

3. The heat sink according to claim 1, wherein the heat sink and the at least one closing plate form a space sealed in gas-tight fashion to accommodate the coil assembly.

4. The heat sink according to claim 1, wherein the mounting section includes steps at a respective contact area.

5. The heat sink according to claim 4, wherein when mounted on the mounting section, the closing plate abuts against a junction between two steps of the mounting section.

6. The heat sink according to claim 1, wherein the heat sink includes at least one channel adapted to be traversed by a coolant during operation of the heat sink, and at least one inlet and at least one outlet for the coolant.

7. The heat sink according to claim 6, wherein in an area of the coolant inlet and in an area of the coolant outlet in each case a connection element is secured with material locking to the heat sink, the connection element adapted to connect to a supply line for the coolant or a drainage line for the coolant.

8. The heat sink according to claim 6, wherein the channels each branch off with a first end section substantially perpendicularly from an entrance area of the heat sink, and open through with a second end section substantially perpendicularly into a discharge area of the heat sink.

9. The heat sink according to claim 1, wherein the heat sink is arranged as a one-piece, 3-D printed unit.

10. The heat sink according to claim 1, wherein mounting elements adapted to fix a coil assembly in position are integrally molded on the heat sink.

11. The heat sink according to claim 1, wherein reinforcement areas of the heat sink extend on the heat sink within a region enclosed by the circumferential mounting section.

12. The heat sink according to claim 1, wherein at least one closing plate is secured with material locking to the mounting section of the heat sink, abuts against a contact area of the mounting section, and together with the heat sink, surrounds a space for accommodating the coil assembly.

13. The heat sink according to claim 11, wherein at least one closing plate is secured with material locking to the mounting section of the heat sink, abuts against a contact area of the mounting section, and together with the heat sink, surrounds a space for accommodating the coil assembly, and wherein the at least one closing plate is supported on the reinforcement areas and welded and fixed in position on the reinforcement areas.

14. A linear motor, comprising:
a primary section including a coil assembly having at least one coil adapted to be energized electrically during operation of the linear motor, and a heat sink according to claim 1, the coil assembly being fixed in position on the heat sink and accommodated in a space enclosed by the heat sink and the at least one closing plate.
